(19) United States
(12) Patent Application Publication
(10) Pub. No.: US 2024/0427023 A1
(43) Pub. Date: Dec. 26, 2024

(54) METHOD FOR DETERMINING WIND SPEED BY MEANS OF A LASER REMOTE SENSOR MOUNTED ON A WIND TURBINE

(71) Applicant: IFP Energies nouvelles, Rueil-Malmaison (FR)

(72) Inventors: Hoai-Nam NGUYEN, RUEIL-MALMAISON CEDEX (FR); Olivier LEPREUX, RUEIL-MALMAISON CEDEX (FR); Fabrice GUILLEMIN, RUEIL-MALMAISON CEDEX (FR)

(21) Appl. No.: 18/683,525

(22) PCT Filed: Aug. 8, 2022
(86) PCT No.: PCT/EP2022/072192

§ 371 Date: Feb. 14, 2024

(30) Foreign Application Priority Data
Aug. 20, 2021 (FR) FR2108790

(51) Int. Cl. G01S 17/95; F03D 7/04; F03D 13/25; G01S 17/00; G01S 17/58

(52) U.S. Cl. CPC G01S 17/95; F03D 7/042; F03D 13/256; G01S 17/006; G01S 17/58; F05B 2240/93; F05B 2270/32

(57) ABSTRACT

The present invention relates to a method implementing measurements obtained with a LiDAR sensor (2) mounted on a wind turbine (1), and measurements obtained with at least one motion sensor (CAM), as well as a LiDAR measurement model (MOD M) and a wind model (MOD V). The method then implements an informative adaptive Kalman filter (KAL) to determine the wind speed (v) at some estimation points. At least one wind speed characteristic (CAR) can then be possibly deduced therefrom, in the rotor plane for example.

### CROSS-REFERENCE TO RELATED APPLICATIONS

Reference is made to PCT/EP2022/072192 filed Aug. 8, 2022, and French Patent Application No. 2108790 filed Aug. 20, 2021, which are incorporated herein by reference in their entirety.

### BACKGROUND OF THE INVENTION

### Field of the Invention

The present invention relates to the field of renewable energies and more particularly to the measurement of the resource of floating wind turbines, the wind, for the purpose of wind prediction, floating wind turbine control (orientation, torque and at least one of speed regulation), diagnosis, monitoring, and floating wind turbine numerical modelling/simulation.

### Description of the Prior Art

A wind turbine allows the kinetic energy from the wind to be converted into electrical or mechanical energy. For wind energy conversion into electrical energy, it is made up of the following elements:
a tower allowing a rotor to be positioned at a sufficient height to enable motion thereof (necessary for horizontal-axis wind turbines) or the rotor is to be positioned at a height enabling it to be driven by a stronger and more regular wind than at ground level. The tower generally houses part of the electrical and electronic components (modulator, control, multiplier, generator, etc.);
a nacelle mounted at the top of the tower, housing mechanical, pneumatic components, and some electrical and electronic components necessary to operate the machine (modulator, control, multiplier, generator, etc.). The nacelle can rotate so as to orient the rotor in the right direction;
a rotor fastened to the nacelle, comprising several blades (generally three) and the hub of the wind turbine. The rotor is driven by the wind energy and it is connected by a mechanical shaft, directly or indirectly (via a gearbox and mechanical shaft system), to an electrical machine (electrical generator) that converts the energy recovered to electrical energy. The rotor is potentially provided with control systems such as a variable-angle blades or aerodynamic brakes; and
possibly a transmission, notably made up of two shafts (mechanical shaft of the rotor and mechanical shaft of the conversion machine) connected by a multiplier (gearbox).

When a wind turbine is a floating turbine, the tower rests on a floating support structure also referred to as floater. Such a floating structure can be connected to the sea bed by anchor lines.

Since the early 1990s, there has been renewed interest in wind power, in particular in the European Union where the annual growth rate is about 20%. This growth is attributed to the inherent possibility for carbon-free electricity generation. In order to sustain this growth, the energy yield of wind turbines still needs to be further improved. The prospect of wind power production increase requires developing effective production tools and advanced control tools in order to improve the performances of the machines. Wind turbines are designed to produce electricity at the lowest possible cost. They are therefore generally built to reach their maximum performance at a wind speed, referred to as “nominal” speed, of approximately 12 m/s. It is not necessary to design wind turbines that maximize their yield at higher wind speeds, which are not common. In case of wind speeds greater than the nominal wind speed of the turbine, it is necessary to lose part of the additional energy contained in the wind to avoid damage to the wind turbine. All wind turbines are therefore designed with a power regulation system.

For this power regulation, controllers have been designed for variable-speed wind turbines. The purpose of the controllers is to maximize the electrical power recovered, to minimize the rotor speed fluctuations, and to minimize the fatigue and the extreme moments of the structure (blades, tower and platform).

To optimize control, it is important to know a wind speed characteristic. Various techniques have been developed to that end.

According to a first technique, using an anemometer allows estimation of a wind speed at one point, but this imprecise technology does not enable measurement of an entire wind field or to know the three-dimensional components of the wind speed.

According to a second technique, a LiDAR (Light Detection And Ranging) sensor can be used. LiDAR is a remote sensing or optical measurement technology based on the analysis of the properties of a beam returned to the emitter. This method is notably used for determining the distance to an object by use of a pulse laser. Unlike radars based on a similar principle, LiDAR sensors use visible or infrared light instead of radio waves.

In the field of wind turbines, LiDAR sensors are announced as essential for proper functioning of large wind turbines, especially now that their size and power is increasing (today 8 MW, soon 15 MW for offshore turbines). This sensor enables remote wind measurements, first allowing wind turbines to be calibrated so that they can deliver maximum power (power curve optimization). For this calibration stage, the sensor can be positioned on the ground and vertically oriented (profiler), which allows measurement of the wind speed and direction, as well as the wind gradient depending on altitude. This application is particularly critical because it allows knowing the energy generating resource. This is important for wind turbine projects since it conditions the financial viability of the project.

A second application sets this sensor on the nacelle of the wind turbine in order to measure the wind field upstream of the turbine while being nearly horizontally oriented. A priori, measuring the wind field upstream of the turbine allows advance knowledge of the turbulence the turbine is going to encounter shortly thereafter. However, current wind turbine control and monitoring techniques do not allow to take account of a measurement performed by a LiDAR sensor by estimating precisely the average wind speed, that is in the rotor plane. Such an application is notably described in patent application FR-3-013,777 (US-2015/145,253).

Besides, one specific feature when using a LiDAR sensor is that the distances from the measurement planes to the rotor plane of the wind turbine can be imposed by the LiDAR user, they can be different from one LiDAR sensor to another, and they can be unknown. In this case, it is not possible to use wind speed determination methods such as those described in patent applications FR-3,068,139 (US-2020/0124,026), FR-3,088,971 (US-2020/0166,650), which require imposing the distance between the measurement planes and the rotor plane of the wind turbine.

When the wind turbine is a floating turbine, it is subjected to at least one of wave motion and to wind power, which may cause at least one of translational and rotational motions of the floating turbine. These motions generate dynamic displacement of the LiDAR sensor relative to a stationary reference frame (terrestrial reference frame for example). This displacement of the LiDAR sensor disturbs analysis of the LiDAR sensor measurements. Indeed, the beams of the LiDAR sensor no longer have constantly the same origin or the same orientation in the stationary reference frame, which also continuously modifies the position of the measurement points. This modification of the measurement point position is all the more significant as the measurement plane is distant from the wind turbine. For example, for a measurement point belonging to a measurement plane 400 m away from the LiDAR sensor, the offset of the measurement point over time between two extreme positions can be about 40 m. In addition, due to the frequency of the wave motion and to wind modifications, motions remain variable over time, which generates a variation in the measurement point position over time. Therefore, for this situation, determination of the wind speed can be erroneous in case of at least one of strong waves and high wind loads.

FIGS. 1 and 2 schematically illustrate this problem by way of non-limitative example. FIG. 1 illustrates a floating wind turbine in vertical position, and FIG. 2 illustrates a floating wind turbine subjected to a motion due to at least one of wind and wave loads. In these figures, the sea level is denoted by MSL. Floating wind turbine 1 comprises a nacelle 3, blades (not shown), a tower 4 and a floater 8. Point O corresponds to a stationary reference point associated with the terrestrial or inertial reference frame. Typically, point O can be a point of the floating structure at sea level. Frame R0 is a stationary direct orthonormal frame with origin O, with its axis x pointing horizontally along the orientation of the nacelle, its axis z ascending vertically and its axis y is arranged to complete the orthonormal basis with the grid Rep being associated with this stationary frame. Point N designates a geometric point in the nacelle. Point L designates the origin of the beams of LiDAR sensor 2. The line segment b represents a measurement beam of the LiDAR sensor. Point P designates a geometric measurement point of beam b of LiDAR sensor 2. The other measurement points of the LiDAR sensor can be deduced in a similar manner by being positioned on measurement beams. Point Nf is the point related to frame R0 that coincides with point N when the assembly of the wind turbine and the floater is at rest (vertical position of FIG. 1). Frame Rb is a variable frame whose origin is point N and whose axis orientation is identical to that of R0 when the assembly of the wind turbine and the floater is at rest. It is noted that, in stationary frame R0 and the associated grid Rep, the inclination of measurement beam b and the position of measurement point P varies greatly between FIGS. 1 and 2.

Onshore wind turbines or offshore wind turbines are equally subjected to motions that penalize LiDAR sensor measurements.

### SUMMARY OF THE INVENTION

The invention determines at least one characteristic of the wind speed, in a precise manner, even for measurements disturbed by motions of the wind turbine, preferably a floating wind turbine, that can be caused by wave or wind loads. The present invention therefore relates to a method using measurements of a LiDAR sensor and measurements of at least one motion sensor, as well as a LiDAR measurement model and a wind model. The method then uses an informative adaptive Kalman filter for determining the wind speed at some estimation points. At least one characteristic of the wind speed can be possibly deduced therefrom, in the rotor plane for example. Motion measurements allow the stress undergone by the wind turbine to be taken into account, in particular when the wind turbine is a floating turbine. Furthermore, combining these measurements with the wind model taking account of the spatial coherence and the temporal coherence, and with the informative adaptive Kalman filter, allows dynamic motions of the wind turbine to be taken into account for determining the wind speed.

The invention relates to a method of determining the wind speed by use of a LiDAR sensor mounted on a wind turbine, preferably a floating wind turbine, and by use of at least one motion sensor mounted on the wind turbine. For this method, the following steps are carried out:
a) constructing a model of the LiDAR measurements;
b) constructing a wind model by accounting for the spatial coherence and the temporal coherence of the wind speed;
c) measuring by use of the LiDAR sensor the wind in at least one measurement plane distant from the wind turbine;
d) measuring by use of the at least one motion sensor the motion of the nacelle of the wind turbine in a stationary reference frame; and
e) determining the wind speed at different estimation points by use of an informative adaptive Kalman filter using the model of the LiDAR measurements constructed in step a), the wind model constructed in step b), the measurements of the LiDAR sensor obtained in step c) and the measurements of the at least one motion sensor obtained in step d), with the estimation points being in the stationary frame.

According to one embodiment, the at least one motion sensor comprises an inertial measurement unit, the inertial measurement unit preferably comprising at least one accelerometer and at least one gyroscope.

According to one implementation, the model of the LiDAR measurements is written as follows: m_{j,x}(k)=aⱼv_{j,x}(k)+bⱼv_{j,v}(k)+cⱼv_{j,x}(k), with m being the measurement, x being the longitudinal direction, j being a measurement beam of the LiDAR sensor, mj,x being the measurement on measurement beam j at distance x, k being the discrete time, v the wind speed, vj,x being the longitudinal component of the wind speed for measurement beam j, vj,y being the transverse component of the wind speed for measurement beam j, vj,z being the vertical component of the wind speed for measurement beam j, aj, bj, cj being measurement coefficients for measurement beam j.

According to an aspect, the spatial coherence of the wind model is a function of a transverse coherence, a vertical coherence and a longitudinal coherence.

According to a feature, the temporal coherence of the wind model is written as follows: w(k)=Aₛw(k−1), with k being the discrete time, o being a vector that comprises first the longitudinal components of the wind speed at n predefined estimation points, and the transverse components of the wind speed for the n predefined estimation points, As is a constant matrix which is the autocorrelation function of the wind speed obtained by a Kaimal spectrum.

According to an embodiment, the informative adaptive Kalman filter is applied to the following equations; wₓ(k)=Aₛwₓ(k−1)+η(k) and

$$\{ \begin{matrix}{w}_{x , {y}_{1}} ( k ) - {f}_{t} ( {w}_{x , {y}_{2}} ( k ) , {y}_{1} - {y}_{2} ) = {ϵ}_{t} ( {x}_{1} , {x}_{2} , {y}_{1} , {y}_{2} , {z}_{1} , {z}_{2} , k ) , \\ {w}_{x , {z}_{1}} - {{w}_{x , {z}_{2}} ( \frac{{z}_{1}}{{z}_{2}} )}^{\text{?}} = {ϵ}_{v} ( {x}_{1} , {x}_{2} , {y}_{1} , {y}_{2} , {z}_{1} , {z}_{2} , k ) , \\ {v}_{x , {x}_{1}} ( k ) - {f}_{l} ( {v}_{x , {x}_{2}} ( k ) , {x}_{1} - {x}_{2} ) = {ϵ}_{l} ( {x}_{1} , {x}_{2} , {y}_{1} , {y}_{2} , {z}_{1} , {z}_{2} , k ) , \\ {m}_{j , x} ( k ) = {a}_{j} {w}_{j , x} ( k ) + {b}_{j} {w}_{j , y} ( k ) + {c}_{j} {v}_{j , z} ( k ) + {ϵ}_{m} ( k )\end{matrix}$$

$$\text{?} \text{indicates text missing or illegible when filed}$$

with k being the discrete time, v being the wind speed, x being the longitudinal component, y₁ and y₂ being two transverse positions having the same longitudinal and vertical values, x₁ and x₂ being two longitudinal positions having the same transverse and vertical values, z₁ and z₂ being two vertical positions having the same longitudinal and transverse values, v_{x,y1} being the longitudinal component of the wind speed at position y₁, v_{x,y2} being the longitudinal component of the wind speed at position y₂, fₜ being a predefined function, v_{x,x1} being the longitudinal component of the wind speed at position x₁, v_{x,x2} being the longitudinal component of the wind speed at position x₂, f₁ being a predefined function, v_{x,z1} being the longitudinal component of the wind speed at position z₁, v_{x,z2} being the longitudinal component of the wind speed at position z₂, αbeing the coefficient of the power law, j being a measurement beam of the LiDAR sensor, m_{j,x} the measurement on measurement beam j being at distance x, v_{j,x} being the longitudinal component of the wind speed for measurement beam j, v_{j,y} being the transverse component of the wind speed for measurement beam j, v_{j,z} being the vertical component of the wind speed for measurement beam j, aⱼ, bⱼ, cⱼ being measurement coefficients for measurement beam j, η t being he noise of the equation of state, εₜ being the transverse noise, εᵥ being the vertical noise, ε₁ the longitudinal noise, εₘ being the measurement noise, Aₛ being a constant matrix which is the autocorrelation function of the wind speed obtained by a Kaimal spectrum.

According to an implementation, the wind speed is determined at different points by use of the following equations:

$$\{ \begin{matrix}N = Q + {A}_{s} {S ( k - 1 \vert k - 1 )}^{- 1} {A}_{s}^{T} \\ S ( k \vert k - 1 ) = {N}^{- 1} \\ {s}^{\text{?}} ( k \vert k - 1 ) = S ( k \vert k - 1 ) {A}_{s} {S ( k - 1 \vert k - 1 )}^{- 1} \hat{s} ( k - 1 \vert k - 1 )\end{matrix}$$

$$\{ \begin{matrix}\hat{s} ( k \vert k ) = \hat{s} ( k \vert k - 1 ) + {C}_{a}^{T} Ry ( k ) \\ S ( k \vert k ) = S ( k \vert k - 1 ) + {C}_{a}^{T} {RC}_{a}\end{matrix} ,$$

$$\text{?} \text{indicates text missing or illegible when filed}$$

and ŵ(k|k)=S(k|k)⁻¹(k|k) with k being the discrete time, s being the information state vector of the informative adaptive Kalman filter, S being the information matrix of the informative adaptive Kalman filter, ŝ(k|k−1) being the estimation of s(k) given the measurements from time k−1, ŝ(k|k) being the estimation of s(k) given the measurements from time k, S(k|k−1) being the information matrix of s(k) given the measurements of time k−1, S(k|k) being the information matrix of s(k) given the measurements of time k, Aₛ being a constant matrix which is the autocorrelation function of the wind speed obtained by the Kaimal spectrum, Q and R being the covariance matrices of noises ε(k) and η(k), Cₐ being obtained by linearizing the output equations around ŵ(k|k−1), and y(k) comprises the measurements of the LiDAR sensor.

According to an embodiment, the method comprises an additional step of determining at least one characteristic of the wind speed, preferably a wind speed characteristic in a vertical plane, in particular in the vertical plane of the rotor of the wind turbine.

The invention further relates to a method of controlling a wind turbine, preferably a floating wind turbine. The following steps are carried out for this method:
a) determining at least one characteristic of the wind speed by use of the method according to one of the above features; and
b) controlling the wind turbine according to the at least one characteristic of the wind speed.

Furthermore, the invention relates to a computer program product comprising code instructions carrying out the steps of a method according to one of the above features, when the program is executed on at least one of a control and diagnosis unit of the wind turbine, preferably the floating wind turbine.

Besides, the invention relates to a LiDAR sensor comprising a processing unit or processor implementing a method according to any one of the above features.

In addition, the invention relates to a wind turbine, preferably a floating wind turbine, comprising a LiDAR sensor according to any one of the above features, the LiDAR sensor being preferably arranged on the nacelle of the wind turbine or in the hub of the wind turbine.

### BRIEF DESCRIPTION OF THE DRAWINGS

Other features and advantages of the method and of the system according to the invention will be clear from reading the description hereafter of embodiments given by way of non-limitative example, with reference to the accompanying drawings wherein:

FIG. 1, already described, illustrates a floating wind turbine in vertical position;

FIG. 2, already described, illustrates a floating wind turbine in a modified position due to loads (wave load for example);

FIG. 3 illustrates the steps of the method of determining the average wind speed according to an embodiment of the invention;

FIG. 4 illustrates a floating wind turbine equipped with a LiDAR sensor according to an embodiment of the invention; and

FIG. 5 illustrates, for a comparative example, average wind speed curves respectively obtained by use of a method according to the prior art, for a measurement plane 50 m from the wind turbine, for a measurement plane 400 m from the wind turbine, and by use of the method according to an embodiment of the invention.

### DETAILED DESCRIPTION OF THE INVENTION

The present invention relates to a method for determining the average wind speed for different estimation points, by use of a LiDAR sensor positioned on a wind turbine, preferably a floating wind turbine.

In the rest of the description, the preferred embodiment implementing a floating wind turbine is described because this type of turbine is subjected to higher wave motions.

However, the invention can also apply to an onshore wind turbine or to a fixed offshore wind turbine.

According to the invention, the LiDAR sensor allows measurement of the wind speed in at least one measurement plane upstream from the wind turbine. There are several types of LiDAR sensors, for example scanning LiDAR sensors, continuous wave or pulsed LiDAR sensors. Within the context of the invention, a pulsed LiDAR is preferably used.

However, the other LiDAR technologies may also be used while remaining within the scope of the invention.

LiDAR sensors provide fast measurement. Therefore, using such a sensor enables fast continuous determination of the wind speed. For example, the sampling rate of the LiDAR sensor can range between 1 and 5 Hz (or more in the future), and it can be 4 Hz. Furthermore, the LiDAR sensor allows obtaining information relative to the wind upstream from the turbine with this information being related to the oncoming wind. The LiDAR sensor can therefore be used for predicting the wind speed in the turbine rotor plane.

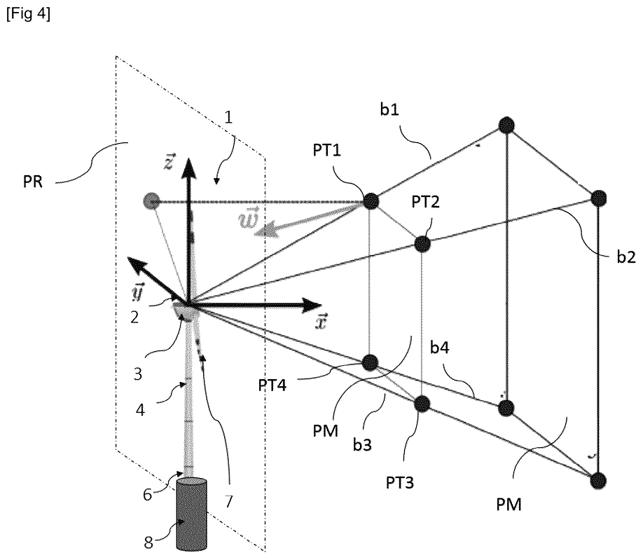

FIG. 4 schematically shows, by way of non-limitative example, a horizontal-axis wind turbine 1 equipped with a LiDAR sensor 2 for the method according to an embodiment of the invention. LiDAR sensor 2 is used to measure the wind speed at a given distance in measurement planes PM (only two measurement planes are shown). Knowing the wind measurement in advance apriori provides a lot of information. This figure also shows axes x, y and z. The reference point of this frame is the center of the rotor. Direction x is the longitudinal direction corresponding to the direction of the rotor axis, upstream from the wind turbine, this direction also corresponds to the measurement direction of LiDAR sensor 2. Direction y, perpendicular to direction x, is the lateral or transverse direction located in a horizontal plane (directions x, y form a horizontal plane). Direction z is the vertical direction (substantially corresponding to the direction of tower 4) pointing up, axis z is perpendicular to axes x and y. The rotor plane is indicated by the rectangle in dotted line PR with it being defined by directions y, z for a zero value of x. Measurement planes PM are planes formed by directions y, z at a distance from rotor plane PR (for a non-zero value of x). Measurement planes PM are parallel to rotor plane PR.

Conventionally, a floating wind turbine converts the kinetic energy of the wind into electrical or mechanical energy. For conversion of wind energy to electrical energy, it is made up of the following elements:
a tower 4 allowing a rotor (not shown) to be positioned at a sufficient height to enable motion thereof (necessary for horizontal-axis wind turbines) at least one of allowing this rotor to be positioned at a height enabling it to be driven by a stronger and more regular wind than at ground level 6 (at sea level for example). Tower 4 can possibly house part of the electrical and electronic components (modulator, control, multiplier, generator, etc.), tower 4 rests on a floating structure 8 providing floating turbine buoyancy, such a floating structure 8 can be connected to the sea bottom by anchor lines,
a nacelle 3 mounted at the top of tower 4, housing mechanical, pneumatic and some electrical and electronic components (not shown, modulator, control, multiplier, generator for example) necessary for operating the machine. Nacelle 3 can rotate to orient the machine in the right direction;
the rotor, fastened to the nacelle, comprising several blades 7 (generally three) and the hub of the wind turbine. The rotor is driven by the wind energy and it is connected by a mechanical shaft, directly or indirectly (via a gearbox and mechanical shaft system), to an electrical machine (electrical generator) (not shown) that converts the energy recovered to electrical energy. The rotor is potentially provided with control systems such as a variable-angle blades or aerodynamic brakes; and
optionally a transmission made up of two shafts (mechanical shaft of the rotor and mechanical shaft of the electrical machine) connected by a transmission (gearbox) (not shown).

As is visible in FIG. 4, which is an example embodiment of a pulsed LiDAR sensor, the LiDAR sensor 2 used comprises four measurement beams or axes (b1, b2, b3, b4). By way of non-limitative example, the method according to the invention also works with a LiDAR sensor comprising any number of beams. The LiDAR sensor performs a spot measurement at each point of intersection of a measurement plane PM and a beam (b1, b2, b3, b4). These measurement points are represented by black circles in FIG. 4, for the first measurement plane PM, the measurement points are denoted by PT1, PT2, PT3 and PT4.

Processing the measurements at these measurement points allows determination of the wind speed in measurement planes PM.

Preferably, LiDAR sensor 2 can be mounted on nacelle 3 of wind turbine 1 or in the hub of wind turbine 1 (that is at the front end of the nacelle in the wind direction).

According to the invention, the wind turbine, preferably a floating wind turbine, is also equipped with at least one motion sensor for measuring the position variations of the wind turbine over time. Such a motion sensor can determine at least one of a translation and a rotation of at least part of the wind turbine. Preferably, at least one of the motion sensors can comprise an accelerometer, a gyroscope, an inclinometer, an inertial measurement unit, for example a MRU (Motion Reference Unit) type sensor that can comprise a unidirectional or a multidirectional sensor, or any similar motion sensor.

For example, an inertial measurement unit can comprise six sensors: three gyrometers measuring the components of the angular velocity vector and three accelerometers measuring the components of the specific force vector (which can be defined as the sum of the external forces other than gravitational divided by the mass). Such an inertial measurement unit can also comprise a calculator providing real-time determination, from the sensor measurements, of attitude angles, velocity vector, position. Such an inertial unit can be of IMU (Inertial Measurement Unit) type, of IRS (Inertial Reference System) type or of INS (Inertial Navigation System) type. It is noted that, generally, an IMU type central unit does not comprise a calculator.

Preferably, the or at least one of the motion sensors can be arranged in the nacelle of the wind turbine. Indeed, the nacelle of the wind turbine undergoes large amplitude motions. Alternatively or cumulatively, at least one of the motion sensors can be arranged in at least one of the tower of the wind turbine, in the rotor of the wind turbine, and on the floating structure.

According to the invention, the method of determining the average wind speed comprises the following steps:
1) Construction of a LiDAR sensor measurement model
2) Construction of a wind model
3) Wind measurement
4) Wind turbine motion measurement
5) Determination of the wind speed
6) Determination of at least one wind speed characteristic (optional step).

Steps 3) to 6) can be carried out in real time or, alternatively, steps 5) and 6) can be carried out offline after measurement steps 3) and 4). Steps 1) and 2) can be carried out offline and prior to steps 3) to 6), and they can be performed in this order, in the reverse order or simultaneously. Furthermore, steps 3) and 4) are preferably carried out simultaneously. All the steps are described in detail in the rest of the description.

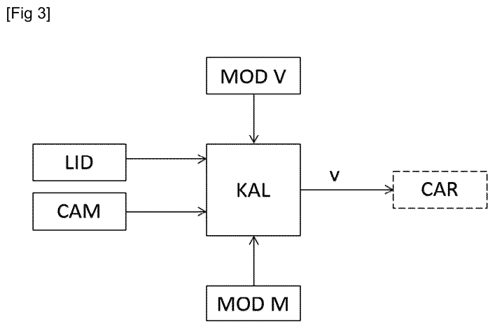

FIG. 3 schematically illustrates, by way of non-limitative example, the steps of the method according to an embodiment of the invention. The method allows determination of the average wind speed in a vertical plane by use of a LiDAR sensor positioned on a wind turbine. A wind model MOD V and a measurement model MOD M can first be constructed offline. Then, the wind is measured LID by use of the LiDAR sensor, and the wind turbine motion is measured CAM by use of at least one motion sensor. The wind speed v is then determined at various points by use of an informative adaptive Kalman filter KAL, which uses wind model MOD V, measurement model MOD M, and measurements LID and CAM. Finally, at least one wind characteristic CAR can be optionally determined from wind speed v at different points.

### 1) Construction of a LiDAR Sensor Measurement Model

This step constructs a model of the LiDAR sensor measurements. It is a model relating the components of the wind speed to the measurement signal from the LiDAR sensor.

According to one embodiment of the invention, the LiDAR sensor measurement model can be written as follows: m_{j,x}(k)=aⱼv_{j,x}(k)+bⱼv_{j,v}(k)+cⱼv_{j,x}(k), with m being the measurement, x being the longitudinal direction, j being a measurement beam of the LiDAR sensor, mj,x being the measurement on measurement beam j at distance x, k being the discrete time, v being the wind speed, vj,x being the longitudinal component of the wind speed for measurement beam j, vj,y being the transverse component of the wind speed for measurement beam j, vj,z being the vertical component of the wind speed for measurement beam j, aj, bj, cj measurement coefficients for measurement beam j.

Measurement coefficients aj, bj, cj depend only on the beam angles of the LiDAR sensor and on the wind turbine orientation angles, and they do not depend on the measurement distances. These measurement coefficients aj, bj, cj can be data provided by the LiDAR sensor manufacturer, or they can be experimentally obtained and corrected with the wind turbine orientation angles.

In a variant, the method can use other LiDAR sensor measurement models.

### 2) Construction of a Wind Model

This step constructs a wind model. The wind model accounts for the spatial coherence and the temporal coherence to define the wind speed and its components at any point in space according to various parameters, notably time and the position in space (therefore according to the coordinates of the point considered in the (x, y, z) system). In other words, a wind model meeting the spatial coherence constraints and the temporal coherence constraints is constructed. These spatial and temporal coherences allow the wind model to be representative of the wind, to provide precise determination of the wind speed at any point and to account for the displacement of the measurement points due to at least one of wave motion and wind.

According to an implementation of the invention, the wind model can determine the longitudinal and transverse components of the wind speed. Alternatively, the wind model can determine the three components of the wind speed.

According to an embodiment of the invention, the spatial coherence used in the wind model can depend on a transverse coherence, a longitudinal coherence and a vertical coherence. The representativity of the wind model is thus improved.

For this embodiment, the transverse coherence can be written by using the equation as follows: v_{x,y1}=fₜ(v_{x,y2},y₁−y₂), with x being the longitudinal component, y₁ and y₂ t being wo transverse positions having the same longitudinal (x₁=x₂=x) and vertical (z₁=z₂=z) values, vx,y₁ being the longitudinal component of the wind speed at position y₁, vx,y₂ being the longitudinal component of the wind speed at position y₂, ft being a known predefined function. Thus, the longitudinal component of the wind speed at point y₁ depends on the longitudinal component of the wind speed at point y₂ and on the distance between points y₁ and y₂. According to an example embodiment, predefined function ft can be an exponential function.

For this embodiment, the vertical coherence can be written by use of the equation as follows:

$${v}_{x , \text{?} 1} = {{v}_{x , \text{?} 2} ( \frac{{z}_{1}}{{z}_{2}} )}^{\text{?}} ,$$

$$\text{?} \text{indicates text missing or illegible when filed}$$

with x being the longitudinal component, z₁ and z₂ being two vertical positions having the same longitudinal (x₁=x₂=x) and transverse (y₁=y₂=y) values, vx,z₁ being the longitudinal component of the wind speed at position z₁, vx,z₂ being the longitudinal component of the wind speed at position z₂, αbeing the coefficient of the power law. For this equation, the reference frame of height z is defined with respect to the average sea level (and not to the LiDAR sensor level). Thus, the longitudinal component of the wind speed at point z₁ depends on the longitudinal component of the wind speed at point z₂ and on the ratio between the heights of points z₁ and z₂. Coefficient α of the power law can be chosen constant, or it can be estimated using LiDAR sensor measurements, for example according to the method described in patent application FR-3,097,644.

For this embodiment, the longitudinal coherence can be written by use of the equation as follows: v_{x,x1}(k)=fₜ(v_{x,x2}(k),x₁−x₂), with x being the longitudinal component, x₁ and x₂ being two longitudinal positions having the same transverse (y₁=y₂=y) and vertical (z₁=z₂=z) values, vx,x1 being the longitudinal component of the wind speed at position x₁, vx,x₂ being the longitudinal component of the wind speed at position x₂, f1 being a known predefined function. Thus, the longitudinal component of the wind speed at point x₁ depends on the longitudinal component of the wind speed at point x₂ and on the distance between points x₁ and x₂. According to an example embodiment, predefined function f1 can be an exponential function.

The temporal coherence is understood to be the variation with time of the wind speed components in a single position, that is for the same values x, y and z. In other words, the temporal coherence can be formulated as a relation between the wind speed components between two consecutive discrete time intervals, denoted by k and k−1.

According to an implementation of the invention, one known temporal coherence is obtained using the Kaimal spectrum that can be defined by:

$${S}_{t} ( f ) = {σ}_{t}^{2} \frac{4 \frac{{L}_{t}}{U}}{{( 1 + 6 f \frac{{L}_{t}}{U} )}^{\frac{L}{3}}} ,$$

with f the frequency in Hertz, t being the component of the wind speed (t can therefore correspond to x, y or z), Sₜ being the Kaimal spectrum of component t of the wind speed, U being the average wind speed at the height of the wind turbine rotor, Lₜ being the integral scale parameter of component t of the wind speed and at being the variance determined by the wind turbulence intensity. Indeed, the Kaimal spectrum allows determination of a discrete transfer function that can relate a wind value at time k to a wind value at time k−1.

For the embodiment, where only the longitudinal and transverse components of the wind speed are determined, let o be a vector of dimensions 2n, which can first comprise the longitudinal components of the wind speed for the n points considered, then the transverse components of the wind speed for the n points considered, or conversely (the order of the components is of no importance). To illustrate this vector o in a simple case, if considering a first point having longitudinal and transverse wind speed components vx₁, vy₁, being and a second point having longitudinal and transverse wind speed components vx₂, vy₂, vector ω can be written for example as follows:

$$ω = {( \begin{matrix}{v}_{x 1} & {v}_{x 2} & {v}_{y 1} & {v}_{y 2}\end{matrix} )}^{T} .$$

Using this notation and noting that the Kaimal spectrum is the Fourier transform of the autocorrelation function of the wind speed, the following equation can be written for the temporal coherence: w(k)=Aₛw(k−1), with Aₛ being a constant matrix which is the autocorrelation function of the wind speed obtained by a Kaimal spectrum. Matrix Aₛ can be obtained from the Kaimal spectrum formula as defined above. Thus, this equation gives the connection between wind speed ω at time k and wind speed ω at time k−1.

Alternatively, for the temporal coherence, the von Karman spectrum or any similar representation can be used.

### 3) Wind Measurement

In this step, the wind is continuously measured in at least one measurement plane distant from the wind turbine, by use of the LiDAR sensor. This measurement corresponds to the signal received by the LiDAR sensor in response to the signal emitted by the LiDAR sensor. Indeed, by interferometry and Doppler effect, part of the laser signal emitted by the LiDAR sensor is reflected by the air molecules at the measurement point and also by the aerosols (suspended dust and microparticles).

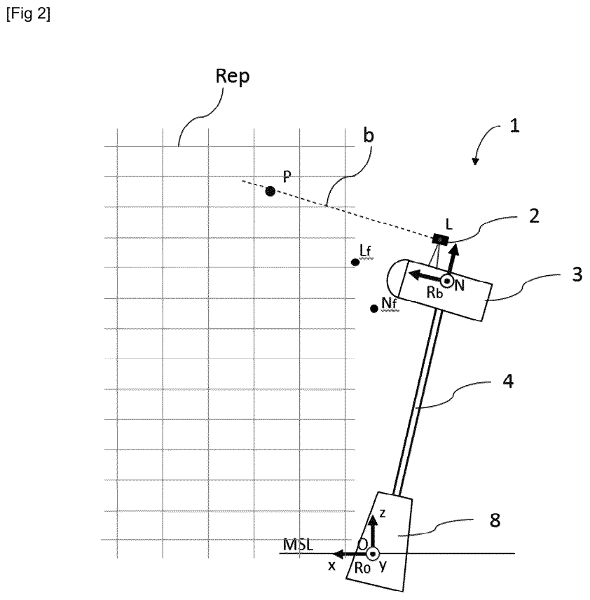

According to an implementation of the invention, the measurement planes can be at a longitudinal distance (along axis x of FIG. 2) from the rotor plane preferably ranging between 50 and 400 m, or more. It is thus possible to determine the evolution of the wind speed over a long distance upstream from the wind turbine, which also allows the accuracy of the average wind speed determination to be improved.

According to an embodiment of the invention, the wind speed measurement can be performed in several measurement planes (whose measurement distances are not imposed by the method according to the invention) to facilitate wind speed determination, which allows the user of the LiDAR sensor to freely parametrize the LiDAR sensor.

According to an aspect of the invention, the measurement can be performed by use of at least two measurement beams of the LiDAR sensor to improve the measurement accuracy.

For the embodiment using a pulsed LiDAR, the measurements are obtained successively at the measurement points illustrated in FIG. 2, starting with beam b1, then beam b2, . . . up to beam b4. An interesting characteristic of this system is that it allows measurement of the projection of the wind speed at several distances, simultaneously, for a given beam. It is thus possible to obtain, for example, 10 successive distances between 50 m and 400 m, at a sampling rate of the LiDAR sensor. At each sampling time, only the measurements of the selected current beam are refreshed.

### 4) Wind Turbine Motion Measurement

This step continuously measures a motion of the wind turbine by use of the at least one motion sensor.

For the embodiment, where the at least one motion sensor is positioned in the nacelle of the wind turbine, the at least one motion sensor can determine:
at least one of surge, sway, and heave position measurements, and at least one of
angular pitch, roll and yaw measurements.

Preferably, the at least one motion sensor can determine all these measurements.

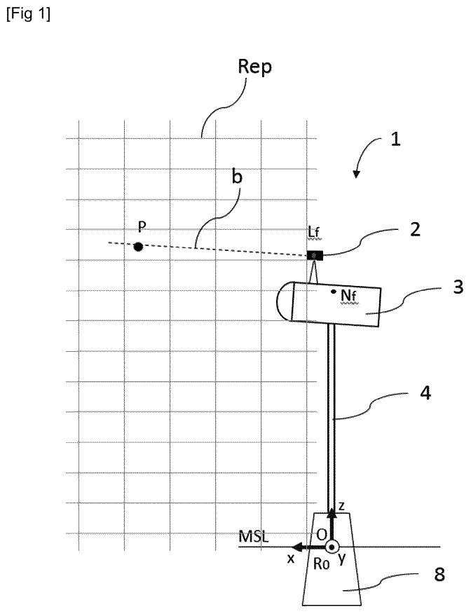

According to the parametrization of FIGS. 1 and 2, if we consider a motion sensor positioned in the nacelle at point N is considered, the motion sensor can notably allow measurement:
vector \vec{N_{f}N} using the position measurements, and
the rotation matrix connecting frame Rb to R0, using the angular measurements.

Using these measurements allows geometrically deducing the position of P in frame R0.

In a variant, other similar measurements can be performed.

Advantageously, the mounting angles of the various sensors (LiDAR and motion sensor) can be included in the geometric parametrization allowing notably the position of the measurement point to be determined.

Alternatively, a point O′ can be advantageously defined as a mobile point in frame R0, so that it is located at sea level, directly below an element attached to the nacelle, typically the LiDAR sensor, the wind turbine motion sensor or the wind turbine hub (blade junction element, corresponding to the center of the rotor plane). By doing so, the position of point P along axis x is relative to the position of this element and it can allow construction of a wind field evaluation grid following the translational motions of this element along axis x. Thus, a grid positioned relative to the wind turbine hub along axis x can be obtained, for example. The distance along axis x between a point of the grid where the wind is estimated and the element in question can thus be obtained more directly.

### 5) Determination of the Wind Speed

This step determines the wind speed at various points of the space upstream from the wind turbine, by use of an informative adaptive Kalman filter using the wind model constructed in step 2, the LiDAR sensor measurement model constructed in step 1, and the measurements performed in steps 3 and 4. The various wind speed determination points are predefined estimation points. Application of the Kalman filter allows obtaining a state observer. The adaptive character of the Kalman filter enables adaptation of the noise covariance matrix according to the wind speed and the location of the measurement points of the LiDAR sensor. Thus, the filter is efficient over a wide wind speed range, regardless of the location of the LiDAR sensor measurement points. Besides, the adaptive Kalman filter is robust to the wind speed variations and the motions of the LiDAR sensor relative to a stationary reference frame. The informative Kalman filter is presented in Dan Simon's book “Simon, D., 2006, Optimal state estimation Kalman Hinfy and nonlinear approaches”. An informative adaptive Kalman filter uses information matrix S, which is the inverse of the covariance matrix, and information state vector s that is connected to state o via information matrix S. In other words, the following equation can be written:

$$\hat{ω} = {S}^{- 1} \hat{s}$$

where ŵ is the estimation of ω and ŝ is the estimation of s.

Such an informative adaptive Kalman filter allows the problem to be solved in a simplified and fast manner, enabling if there is a need for real-time application of the method according to the invention (such a real-time application would not be possible with a conventional adaptive Kalman filter. Moreover, a particular characteristic of the estimation problem is that the number of states is much smaller than the number of output equations. Therefore, the problem of estimating o(k) becomes the state estimation problem. Estimation of o(k) by use of the Kalman filter can therefore take much longer than what is possible for a real-time application, or for a post analysis. For example, the Kalman filter can take several days for one hour of data measured by the LiDAR sensor and the at least one motion sensor).

It is noted that a state observer or a state estimator is, in automation and systems theory, an extension of a model represented as a state representation. When the state of the system is not measurable, an observer allowing the state to be reconstructed from a model is constructed.

For an embodiment using the equations illustrated in step 2, the following state model can be written, with the equation of state; vₓ(k)=Aₛvₓ(k−1)+η(k) and the output equations:

$$\{ \begin{matrix}{w}_{x , {y}_{1}} ( k ) - {f}_{t} ( {w}_{x , {y}_{2}} ( k ) , {y}_{1} - {y}_{2} ) = {ϵ}_{t} ( {x}_{1} , {x}_{2} , {y}_{1} , {y}_{2} , {z}_{1} , {z}_{2} , k ) , \\ {w}_{x , {z}_{1}} - {{w}_{x , {z}_{2}} ( \frac{{z}_{1}}{{z}_{2}} )}^{α} = {ϵ}_{v} ( {x}_{1} , {x}_{2} , {y}_{1} , {y}_{2} , {z}_{1} , {z}_{2} , k ) , \\ {v}_{x , {x}_{1}} ( k ) - {f}_{l} ( {v}_{x , {x}_{2}} ( k ) , {x}_{1} - {x}_{2} ) = {ϵ}_{l} ( {x}_{1} , {x}_{2} , {y}_{1} , {y}_{2} , {z}_{1} , {z}_{2} , k ) , \\ {m}_{j , x} ( k ) = {a}_{j} {w}_{j , x} ( k ) + {b}_{j} {w}_{j , y} ( k ) + {c}_{j} {v}_{j , z} ( k ) + {ϵ}_{m} ( k )\end{matrix}$$

with η being the noise of the equation of state, εₜ being the transverse noise, εᵥ being the vertical noise, ε₁ being the longitudinal noise and εₘ being the measurement noise.

Thus, the problem of estimating vector ω(k) becomes a state estimation problem, which does not require imposing the position of the measurement planes of the LiDAR sensor. One way of estimating the unknown state vector ω(k), which can take into account the information on noises η(k) and ε(k), is applying the algorithm of the informative adaptive Kalman filter, with the following notation:

$$ε = ( \begin{matrix}{ε}_{t} \\ {ε}_{v} \\ {ε}_{l} \\ {ε}_{m}\end{matrix} ) .$$

Indeed, the informative adaptive Kalman filter provides the solution to the optimization problem:

$${min}_{w ( k )} {J}_{r} ( k ) with \\ {J}_{r} ( k ) = \{ {( w ( 0 ) - \overline{w} ( 0 ) )}^{T} {P}_{0}^{- 1} ( w ( 0 ) - \overline{w} ( 0 ) ) + {\sum }_{i = 1}^{k} ( {η ( j - 1 )}^{T} {Q}^{- 1} η ( j - 1 ) + {ϵ ( j )}^{T} {R}^{- 1} ϵ ( j ) ) \}$$

where P₀, Q and R are adjustment matrices of suitable dimensions and ω(0) is the average value of the initial state ω̅(0).

In order to solve this optimization problem by use of the informative adaptive Kalman filter, the following hypotheses can be made, notably for a mathematical interpretation of P0, Q and R:
s(0) is a random vector uncorrelated with noises η(k) and ε(k)
s(0) has a known average s̅(0) with P₀ as the covariance matrix, i.e.:

$${S}_{0}^{- 1} = E [ ( s ( 0 ) - \overline{s} ( 0 ) ) {( s ( 0 ) - \overline{s} ( 0 ) )}^{T} ]$$

η(k) and ε(k) are zero-mean uncorrelated white noise processes with covariance matrices Q and R respectively, i.e.:

$$E [ η ( k ) {η ( j )}^{T} ] = \{ \begin{matrix}Q & if k = j \\ 0 & if k \neq j\end{matrix} \\ E [ ϵ ( k ) {ϵ ( j )}^{T} ] = \{ \begin{matrix}R & if k = j \\ 0 & if k \neq j\end{matrix} \\ E [ ϵ ( k ) {η ( j )}^{T} ] = 0 for all k , j$$

This last hypothesis implies that Q and R are symmetric positive semidefinite matrices.

Furthermore, given that, in the state model, noises εl, εv, and εt depend on the coordinates of the measurement points, covariance matrix R is adapted according to the measurement distances. According to one embodiment, R can be a polynomial function of the measurement distances. Alternatively, R can be obtained from a map, a neural network, etc.

The following notations can be adopted:
ŝ(k|k−1) is the estimation of information state vector s(k) given the measurements performed until time k−1, i.e. y(k−1), y(k−2), . . .
ŝ(k|k) is the estimation of information state vector s(k) given the measurements performed until time k, i.e. y(k−1), y(k−2), . . .
S(k|k−1) is the information matrix of vector s(k) given the measurements performed until time k−1, i.e. y(k−1), y(k−2), . . . and
S(k|k) is the information matrix of vector s(k) given the measurements performed until time k, i.e. y(k−1), y(k−2), . . .

Then, the algorithm of the informative adaptive Kalman filter is used to determine the wind speed at various points, using the following equations:

On the one hand, a temporal update:

$$\{ \begin{matrix}N = Q + {A}_{s} {S ( k - 1 \vert k - 1 )}^{- 1} {A}_{s}^{T} \\ S ( k \vert k - 1 ) = {N}^{- 1} \\ \hat{s} ( k \vert k - 1 ) = S ( k \vert k - 1 ) {A}_{s} {S ( k - 1 \vert k - 1 )}^{- 1} \hat{s} ( k - 1 \vert k - 1 )\end{matrix}$$

On the other hand, a measurement update:

$$\{ \begin{matrix}\hat{s} ( k \vert k ) = \hat{s} ( k \vert k - 1 ) + {C}_{a}^{T} Ry ( k ) \\ S ( k \vert k ) = S ( k \vert k - 1 ) + {C}_{a}^{T} {RC}_{a}\end{matrix}$$

with Cₐ being obtained by linearizing the output equations of the state model around ŵ(k|k−1) and y(k) being the measurements of the LiDAR sensor.

Once ŝ(k|k), S(k|k) is obtained, the wind speed vector ŵ(k|k) can be calculated as follows:

$$\hat{w} ( k \vert k ) = {S ( k \vert k )}^{- 1} \hat{s} ( k \vert k )$$

Thus, these steps allow determination vector o, which comprises the components of the wind speed at several points. In other words, these steps allow determining the components of the wind speed at several points.

### 6) Determination of at Least One Wind Speed Characteristic (Optional Step)

This optional step determines at least one characteristic of the wind, preferably in a vertical plane, for example a vertical plane at the rotor, by use of the wind speeds determined in step 5.

According to one embodiment, the average wind speed can be the average of the longitudinal components of the wind speed in the rotor plane being considered.

According to a preferred embodiment of the invention, the wind characteristic can be the REWS (Rotor Effective Wind Speed), which is an estimation of a wind speed at the rotor plane commonly used for at least one of control diagnosis, monitoring of a wind turbine and numerical modelling/simulation of a wind turbine.

In a variant, the wind characteristic can be the RAWS (Rotor Average Wind Speed), which is the average wind speed in the rotor plane in the area formed by the wind turbine blades.

Alternatively, other wind characteristics can be determined in this step. These characteristics can notably be selected from among:
the average wind speed,
the wind speed field, notably in the rotor plane,
the effective average wind speed, notably in the rotor plane,
information on spatial wind inhomogeneities, notably in the rotor plane, and
information on turbulence, etc.

The present invention also relates to a method of controlling a wind turbine and preferably a floating wind turbine, equipped with a LiDAR sensor and at least one motion sensor. The following steps are carried out for this method:
determining at least one wind speed characteristic by use of the method of determining the wind speed according to any one of the variants described above; and
controlling the wind turbine according to the at least one wind speed characteristic thus determined.

Precise real-time determination of the wind speed allows suitable wind turbine control in terms of minimization of the effects on the turbine structure and maximization of the recovered power. Indeed, through this control, the LiDAR sensor allows reducing the loads on the structure, whose blades and tower represent 54% of the cost. Using a LiDAR sensor therefore allows optimizing the wind turbine structure and thus to reduce the costs and maintenance.

The method can further comprise an intermediate step of determining the wind speed in the rotor plane of the wind turbine from the wind speed determined by the method. The wind displacement time between the vertical plane and the rotor plane can therefore be taken into account (it can be calculated notably by considering Taylor's frozen turbulence hypothesis). It is also possible to account for the induction phenomenon between the vertical plane and the rotor plane (by use of an induction factor for example), the induction phenomenon reflecting the wind deceleration upstream from the wind turbine related to the presence of the wind turbine blades. The wind turbine is then controlled according to the wind speed in the rotor plane.

According to an implementation of the invention, at least one of the inclination angle of the blades and the electrical recovery torque of the wind turbine generator can be controlled according to the wind speed. Other types of regulation devices can be used.

According to an embodiment of the invention, at least one of the inclination angle of the blades and the electrical recovery torque can be determined by use of wind turbine maps according to the wind speed at the rotor. For example, the control method described in patent application FR-2,976,630 A1 (US 2012/0321,463) can be applied.

The present invention further relates to a method for at least one diagnosis and monitoring of a wind turbine, preferably a floating wind turbine. For this implementation, the method can carry out the steps of the method of determining the wind speed according to any one of the variants or variant combinations as follows:
carrying out measurements by use of the LiDAR sensor and of the at least one motion sensor, and recording the measurements
offline, carrying out steps 5 and optionally 6 described above for the recorded measurements; and
monitoring the operation of the wind turbine or deducing a wind turbine operation diagnosis according to the speed, for example by comparing the wind speed or a wind speed characteristic with other measurements, such as the power produced by the wind turbine, the rotational speed of the blades, etc.

Furthermore, the invention relates to a computer program product comprising code instructions designed to carry out the steps of one of the methods described above (method of determining the wind speed in the rotor plane, control method). The program can be executed on a LiDAR sensor processor or any similar device linked to the LiDAR sensor or to the wind turbine.

According to an aspect, the present invention also relates to a LiDAR sensor for a wind turbine, comprising a processor configured to implement one of the methods described above (method of determining the wind speed, control method).

According to an implementation of the invention, the LiDAR sensor can be a scanning LiDAR sensor, a continuous wave LiDAR sensor or a pulsed LiDAR sensor. The LiDAR sensor is preferably a pulsed LiDAR sensor.

The invention also relates to a wind turbine equipped with a LiDAR sensor as described above. Preferably, the invention relates to an offshore floating wind turbine equipped with a LiDAR sensor as described above. According to an embodiment of the invention, the LiDAR sensor can be arranged on the nacelle of the wind turbine or in the hub of the turbine (at the end of the nacelle of the wind turbine). The LiDAR sensor is so oriented as to perform a measurement of the wind upstream from the turbine (i.e. before the wind turbine and along the longitudinal axis thereof, designated by axis x in FIG. 4). According to an embodiment, the wind turbine can be identical to the wind turbine illustrated in FIGS. 1, 2 or 4.

For the embodiment of the control method, the wind turbine can comprise control, for example for control of the pitch angle of at least one blade of the wind turbine or of the electrical torque, for implementing the control method according to the invention.

It is clear the invention is not limited to the embodiments described above by way of example and that it encompasses any variant embodiment.

### COMPARATIVE EXAMPLE

The features and advantages of the method according to the invention will be clear from reading the example hereafter.

For this comparative example, a floating wind turbine is equipped with a sonic anemometer, a LiDAR sensor and an inertial measurement unit MRU. The sonic sensor is a sensor known from the prior art, allowing to determine the wind speed at a single point, this sonic sensor being arranged on the nacelle of the wind turbine. The measurements provided by this sensor are processed by an algorithm implemented by the wind turbine supervisor, referred to as “nacelle transfer function”, so as to have a quantity representative of the “free” wind speed, that is corrected for the deceleration due to the induction zone of the wind turbine. The corresponding time series is filtered with a non-causal lowpass filter to remove the very high measurement noise level of the sonic sensor, notably due to its position in the wake of the blades. The reference average speed REWS is thus obtained.

Furthermore, the method according to an embodiment of the invention is applied by carrying out measurements by use of the LiDAR sensor at least in a 50 m measurement plane and in a 400 m measurement plane, to obtain the average speed REWS.

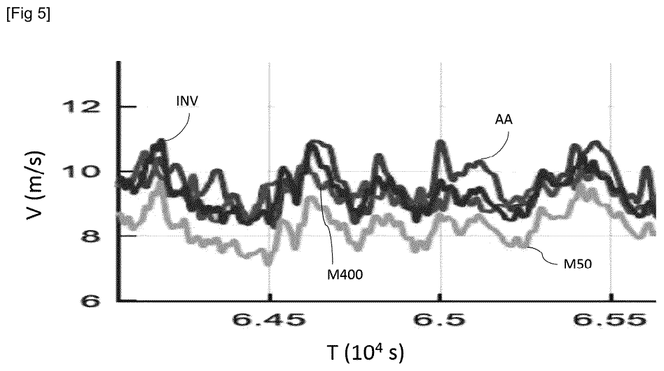

FIG. 5 illustrates curves of the wind speed V in m/s as a function of time T. In this figure, curve AA corresponds to the REWS (Rotor Effective Wind Speed) value determined by the sonic sensor according to the prior art, curve M50 corresponds to the wind speed value in the 50 m measurement plane, curve M400 corresponds to the wind speed value in the 400 m measurement plane, and curve INV corresponds to the REWS value obtained with the method according to an embodiment of the invention from measurements in the 50 m and 400 m measurement planes. It is noted that curves AA and INV are close, therefore the method according to the invention allows determination of the wind speed in a similar manner to the method according to the prior art AA. Furthermore, it is noted that the wind speed M50 is less than the wind speed M400, which corresponds to the induction phenomenon corresponding to the wind deceleration due to the wind turbine in the wind field. The REWS determined with the method according to the invention INV is similar to wind speed M400, and it has dynamics similar to those of wind speed M50.

1-12. (canceled)

13. A method of determining wind speed by use of a LiDAR sensor mounted on a wind turbine, and by use of at least one motion sensor mounted on the wind turbine, comprising steps of:
a) constructing a model of the LiDAR measurements;
b) constructing a wind model by accounting for spatial coherence and temporal coherence of the wind speed;
c) measuring by use of the LiDAR sensor the wind speed in at least one measurement plane distant from the wind turbine;
d) measuring by use of the at least one motion sensor mounted on a nacelle of the wind turbine in a stationary reference frame; and
e) determining the wind speed at different estimation points by use of an informative adaptive Kalman filter using the model of the LiDAR measurements constructed in step a), the wind model being constructed in step b), the measurements of the LiDAR sensor obtained in step c) and the measurements of the at least one motion sensor obtained in step d), the estimation points being in the stationary reference frame.

14. A method in accordance with claim 13, wherein the wind turbine is a floating turbine.

15. A method as claimed in claim 13, wherein the at least one motion sensor comprises an inertial measurement unit, comprising at least one accelerometer and at least one gyroscope.

16. A method as claimed in claim 13, wherein the model of the LiDAR measurements is written as follows: m_{j,x}(k)=aⱼv_{j,x}(k)+bⱼv_{j,x}(k)+eⱼv_{j,x}(k), with m being the measurement, x being the longitudinal direction, j being a measurement beam of the LiDAR sensor, mj,x being the measurement on measurement beam j being at distance x, k being the discrete time, v being the wind speed, v_{j,x} being the longitudinal component of the wind speed for measurement beam j, vj,y being the transverse component of the wind speed for measurement beam j, vj,z being the vertical component of the wind speed for measurement beam j, and aj, bj, and cj being measurement coefficients for measurement beam j.

17. A method as claimed in claim 14, wherein the model of the LiDAR measurements is written as follows: m_{j,x}(k)=aⱼv_{j,x}(k)+bⱼv_{j,x}(k)+eⱼv_{j,x}(k), with m being the measurement, x being the longitudinal direction, j being a measurement beam of the LiDAR sensor, mj,x being the measurement on measurement beam j being at distance x, k being the discrete time, v being the wind speed, v_{j,x} being the longitudinal component of the wind speed for measurement beam j, vj,y being the transverse component of the wind speed for measurement beam j, vj,z being the vertical component of the wind speed for measurement beam j, and aj, bj, and cj being measurement coefficients for measurement beam j.

18. A method as claimed in claim 13, wherein the spatial coherence of the wind model is a function of a transverse coherence, a vertical coherence and a longitudinal coherence.

19. A method as claimed in claim 14, wherein the spatial coherence of the wind model is a function of a transverse coherence, a vertical coherence and a longitudinal coherence.

20. A method as claimed in claim 13, wherein the temporal coherence of the wind model is written as follows: w(k)=Aₛw(k−1), with k being discrete time, ω being a vector comprising first the longitudinal components of the wind speed at n predefined estimation points, and transverse components of the wind speed for the n predefined estimation points, and Aₛ being a constant matrix which is the autocorrelation function of the wind speed obtained by a Kaimal spectrum.

21. A method as claimed in claim 14, wherein the temporal coherence of the wind model is written as follows: w(k)=Aₛw(k−1), with k being discrete time, o being a vector comprising first the longitudinal components of the wind speed at n predefined estimation points, and transverse components of the wind speed for the n predefined estimation points, and Aₛ being a constant matrix which is the autocorrelation function of the wind speed obtained by a Kaimal spectrum.

22. A method as claimed in claim 13, wherein the informative adaptive Kalman filter is applied to the following equations: wₓ(k)=Aₛwₓ(k−1)+η(k) and
$$\{ \begin{matrix}{w}_{x , {y}_{1}} ( k ) - {f}_{t} ( {w}_{x , {y}_{2}} ( k ) , {y}_{1} - {y}_{2} ) = {ϵ}_{t} ( {x}_{1} , {x}_{2} , {y}_{1} , {y}_{2} , {z}_{1} , {z}_{2} , k ) , \\ {w}_{x , {z}_{1}} - {{w}_{x , {z}_{2}} ( \frac{{z}_{1}}{{z}_{2}} )}^{α} = {ϵ}_{v} ( {x}_{1} , {x}_{2} , {y}_{1} , {y}_{2} , {z}_{1} , {z}_{2} , k ) , \\ {v}_{x , {x}_{1}} ( k ) - {f}_{l} ( {v}_{x , {x}_{2}} ( k ) , {x}_{1} - {x}_{2} ) = {ϵ}_{l} ( {x}_{1} , {x}_{2} , {y}_{1} , {y}_{2} , {z}_{1} , {z}_{2} , k ) , \\ {m}_{j , x} ( k ) = {a}_{j} {w}_{j , x} ( k ) + {b}_{j} {w}_{j , y} ( k ) + {c}_{j} {v}_{j , z} ( k ) + {ϵ}_{m} ( k )\end{matrix}$$
with k being the discrete time, v being the wind speed, x being the longitudinal component, y¹ and y₂ being two transverse positions having the same longitudinal and vertical values, x₁ and x₂ being two longitudinal positions having the same transverse and vertical values, z₁ and z₂ being two vertical positions having the same longitudinal and transverse values, v_{x,y1} being the longitudinal component of the wind speed at position y₁, v_{x,y2} being a longitudinal component of the wind speed at position y₂, fₜ being a predefined function, v_{x,x1} being a longitudinal component of the wind speed at position x₁, v_{x,x2} being a longitudinal component of the wind speed at position x₂, f₁ being a predefined function, v_{x,z1} being a longitudinal component of the wind speed at position z₁, v_{x,z2} being a longitudinal component of the wind speed at position z₂, αbeing a coefficient of the power law, j being a measurement beam of the LiDAR sensor, m_{j,x} being the measurement on measurement beam j at distance x, v_{j,x} being a longitudinal component of the wind speed for measurement beam j, v_{j,y} being a transverse component of the wind speed for measurement beam j, v_{j,z} being a vertical component of the wind speed for measurement beam j, aⱼ, bⱼ, cⱼ being measurement coefficients for measurement beam j, η being noise of the equation of state, εₜ being transverse noise, εᵥ being vertical noise, εᵢ being longitudinal noise, εₘ being measurement noise, Aₛ being a constant matrix which is the autocorrelation function of the wind speed obtained by a Kaimal spectrum.

23. A method as claimed in claim 14, wherein the informative adaptive Kalman filter is applied to the following equations: wₓ(k)=Aₛw(k−1)+η(k) and
$$\{ \begin{matrix}{w}_{x , {y}_{1}} ( k ) - {f}_{t} ( {w}_{x , {y}_{2}} ( k ) , {y}_{1} - {y}_{2} ) = {ϵ}_{t} ( {x}_{1} , {x}_{2} , {y}_{1} , {y}_{2} , {z}_{1} , {z}_{2} , k ) , \\ {w}_{x , {z}_{1}} - {{w}_{x , {z}_{2}} ( \frac{{z}_{1}}{{z}_{2}} )}^{α} = {ϵ}_{v} ( {x}_{1} , {x}_{2} , {y}_{1} , {y}_{2} , {z}_{1} , {z}_{2} , k ) , \\ {v}_{x , {x}_{1}} ( k ) - {f}_{l} ( {v}_{x , {x}_{2}} ( k ) , {x}_{1} - {x}_{2} ) = {ϵ}_{l} ( {x}_{1} , {x}_{2} , {y}_{1} , {y}_{2} , {z}_{1} , {z}_{2} , k ) , \\ {m}_{j , x} ( k ) = {a}_{j} {w}_{j , x} ( k ) + {b}_{j} {w}_{j , y} ( k ) + {c}_{j} {v}_{j , z} ( k ) + {ϵ}_{m} ( k )\end{matrix}$$
with k being the discrete time, v being the wind speed, x being the longitudinal component, y₁ and y₂ being two transverse positions having the same longitudinal and vertical values, x₁ and x₂ being two longitudinal positions having the same transverse and vertical values, z₁ and z₂ being two vertical positions having the same longitudinal and transverse values, v_{x,y1} being the longitudinal component of the wind speed at position y₁, v_{x,y2} being a longitudinal component of the wind speed at position y₂, fₜ being a predefined function, v_{x,x1} being a longitudinal component of the wind speed at position x₁, v_{x,x2} being a longitudinal component of the wind speed at position x₂, f₁ being a predefined function, v_{x,z1} being a longitudinal component of the wind speed at position z₁, v_{x,z2} being a longitudinal component of the wind speed at position z₂, α being a coefficient of the power law, j being a measurement beam of the LiDAR sensor, m_{j,x} being the measurement on measurement beam j at distance x, v_{j,x} being a longitudinal component of the wind speed for measurement beam j, v_{j,y} being a transverse component of the wind speed for measurement beam j, v_{j,z} being a vertical component of the wind speed for measurement beam j, aⱼ, bⱼ, cⱼ being measurement coefficients for measurement beam j, η being noise of the equation of state, εₜ being transverse noise, εᵥ being vertical noise, εᵢ being longitudinal noise, εₘ being measurement noise, Aₛ being a constant matrix which is the autocorrelation function of the wind speed obtained by a Kaimal spectrum.

24. A method as claimed in claim 13, wherein the wind speed (v) is determined at different points by use of the following equations:
$$\{ \begin{matrix}N = Q + {A}_{s} {S ( k - 1 \vert k - 1 )}^{- 1} {A}_{s}^{T} \\ S ( k \vert k - 1 ) = {N}^{- 1} \\ \hat{s} ( k \vert k - 1 ) = S ( k \vert k - 1 ) {A}_{s} {S ( k - 1 \vert k - 1 )}^{- 1} \hat{s} ( k - 1 \vert k - 1 )\end{matrix} \\ \{ \begin{matrix}\hat{s} ( k \vert k ) = \hat{s} ( k \vert k - 1 ) + {C}_{a}^{T} Ry ( k ) \\ S ( k \vert k ) = S ( k \vert k - 1 ) + {C}_{a}^{T} {RC}_{a}\end{matrix} ,$$
and ŵ(k|k)=S(k|k)⁻¹S(k|k) with k being discrete time, s being an information state vector of the informative adaptive Kalman filter, S being an information matrix of the informative adaptive Kalman filter, ś(k|k−1) being an estimation of s(k) given measurements from time k−1, ŝ(k|k) being an estimation of s(k) given measurements from time k, S(k|k−1) being an information matrix of s(k) given measurements of time k−1, S(k|k) being an information matrix of s(k) given measurements of time k, Aₛ being a constant matrix which is an autocorrelation function of the wind speed obtained by the Kaimal spectrum, Q and R being covariance matrices of noises ε(k) and η(k), Cₐ is obtained by linearizing the output equations around ŵ(k|k−1) and y(k) comprises measurements of the LiDAR sensor.

25. A method as claimed in claim 14, wherein the wind speed (v) is determined at different points by use of the following equations:
$$\{ \begin{matrix}N = Q + {A}_{s} {S ( k - 1 \vert k - 1 )}^{- 1} {A}_{s}^{T} \\ S ( k \vert k - 1 ) = {N}^{- 1} \\ \hat{s} ( k \vert k - 1 ) = S ( k \vert k - 1 ) {A}_{s} {S ( k - 1 \vert k - 1 )}^{- 1} \hat{s} ( k - 1 \vert k - 1 )\end{matrix} \\ \{ \begin{matrix}\hat{s} ( k \vert k ) = \hat{s} ( k \vert k - 1 ) + {C}_{a}^{T} Ry ( k ) \\ S ( k \vert k ) = S ( k \vert k - 1 ) + {C}_{a}^{T} {RC}_{a}\end{matrix} ,$$
and ŵ(k|k)=S(k|k)⁻¹ŝ(k|k,) with k being discrete time, s being an information state vector of the informative adaptive Kalman filter, S being an information matrix of the informative adaptive Kalman filter, ŝ(k|k−1) being an estimation of s(k) given measurements from time k−1, ś(k|k) being an estimation of s(k) given measurements from time k, S(k|k−1) being an information matrix of s(k) given measurements of time k−1, S(k|k) being an information matrix of s(k) given measurements of time k, Aₛ being a constant matrix which is an autocorrelation function of the wind speed obtained by the Kaimal spectrum, Q and R being covariance matrices of noises ε(k) and η(k), Cₐ is obtained by linearizing the output equations around ŵ(k|k−1) and y(k) comprises measurements of the LiDAR sensor.

26. A method as claimed in claim 13, comprising determining at least one characteristic of the wind speed in a vertical plane of the rotor of the wind turbine.

27. A method as claimed in claim 14, comprising determining at least one characteristic of the wind speed in a vertical plane of the rotor of the wind turbine.

28. A method of controlling a wind turbine comprising steps of:
a) determining at least one characteristic of the wind speed by use of the method as claimed in claim 13; and
b) controlling the wind turbine according to the at least one characteristic of the wind speed.

29. A method of controlling a wind turbine comprising steps of:
c) determining at least one characteristic of the wind speed by use of the method as claimed in claim 14; and
d) controlling the wind turbine according to the at least one characteristic of the wind speed.

30. A computer program product, comprising code instructions which carry out steps of the method as claimed in claim 13, with the program being executed on one of a control and diagnosis unit of the wind turbine.

31. A LiDAR sensor comprising a processor implementing a method as claimed in claim 13.

32. A wind turbine comprising a LiDAR sensor as claimed in claim 31, wherein the LiDAR sensor is located on the nacelle of the wind turbine or in hub of the wind turbine.
